(19) United States
(12) Patent Application Publication
(10) Pub. No.: US 2008/0205233 A1
(43) Pub. Date: Aug. 28, 2008

(54) Predicting Dvd Recordable Recording Parameters in Dual Layer Discs

(75) Inventor: Wooi Liang Chin, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,469

(22) PCT Filed: May 12, 2006
(86) PCT No.: PCT/IB2006/051492

§ 371 Date: Nov. 26, 2007

(30) Foreign Application Priority Data
May 30, 2005 (EP) 05104616.7

(51) Int. Cl. G11B 7/20

(52) U.S. Cl. 369/94

(57) ABSTRACT

A method and apparatus for adjusting operating conditions when shifting from a first layer to a second layer during recording of a dual layer DVD. During calibration of the first layer before recording, parameters for differential laser power and beta target between the two layers are obtained from information fields of the disk. The distance between the layers is measured. When shifting from layer one to layer two, the laser power and beta target for layer two are obtained by using the current values immediately before shifting with addition of the differential obtained during calibration. The focus signal is adjusted by adding the difference compensated for temperature deviations. The tilt signal is unamended. In this way, the shift between layer one and layer two can be performed fastly without separate calibration.

The present invention relates to a method of recording at a multiple layer optical carrier, and more specifically to adjusting operating conditions when shifting from a first layer to a second layer during such recording.

During recording of an optical carrier, such as an optical disk, for example a CD disk, a magneto-optical disk or a DVD disk, several factors should be taken into account. The optical carrier may be placed in a disc drive apparatus, which rotates the carrier with a predetermined speed.

The disk drive may further comprise a recording device having an optical unit comprising a light source, such as a laser, for recording or writing on the optical carrier.

The laser beam should be focused on the optical layer in the optical disk. A focus actuator of the optical unit may control the focal distance so that focus is always maintained.

The optical carrier comprises tracks along which the recording should take place. Such tracks may be arranged in a continuous spiral pattern or be multiple circular concentric tracks. The optical unit may be controlled by a servomechanism, which moves the optical unit in a path coinciding with a radius of the optical carrier in order to follow such tracks.

Often, there is a small deviation of the tracks from the concentricity, resulting in the fact that the tracks move back and forth in the radial direction when they pass the optical unit during one revolution. The optical unit is consequently provided with a servomechanism that follows such non-concentricity by moving the optical unit back and forth in the radial direction during one revolution of the optical disk.

Moreover, the disk may not be completely planar at the surface facing the optical unit, which may be the bottom surface. The optical disk may have a slight umbrella shape or be otherwise irregular in the radial direction. As mentioned above, the optical unit is moved back and forth in the radial direction during one revolution. If such movement does not take place parallel with the local radial tangent of the disk surface, the focal distance will vary considerable. However, if the radial movement takes place according to the radial tangent, focal adjustments may be minimized. Consequently, the optical unit may be provided with a tilt actuator, which adjusts the tilt of the optical unit so that the radial movement takes place parallel with the local tangent of the optical disk surface. The adjustment may take place once at the start of the operation, or intermittently several times during the operation, for example once per ten tracks, or dynamically.

The power of the laser source should have a suitable value in relation to the characteristics of the optical carrier to be written upon. Thus, it is known to perform a laser calibration procedure before the actual recording operation.

WO 2004/109693 discloses a calibration procedure, whereupon the optical power of the laser source is calibrated by setting the laser power to an initial test setting and writing a test pattern in a portion of the storage space specifically reserved for the purpose of calibration. After writing this test pattern, the written data is read and a test is performed if the write operation is adequate. From the optical read signal, an optimal power setting is calculated. The calibration procedure may be repeated with the laser power adjusted to the calculated setting for refining the power setting. The optimal laser power may be calculated from two parameters obtained from the read signal commonly designed as β (beta) and m (modulation). There are several formulas for calculating optimal power from these parameters.

The above-mentioned control signals of the focus, tilt, power and beta are influenced by different factors. In a dual or multiple layer DVD disk, when the recording shifts from a first layer to a second layer, a new calibration of the control signals is normally required. Such calibration may take several seconds, up to 20 seconds or even more. During such calibration, the recording data needs to be buffered in a memory. If writing is performed by a data rate of 9.8 Mbit per second, a buffer memory capacity of 24.5 Mbyte is required only for taking care of the shift time.

Thus, in order to save memory, and in order to make the process of shifting between the two layers during recording as smooth as possible, there is a demand for a process that can make the shift considerably faster.

If calibration takes place during the shift between the two layers, there is a risk that the calibration fails and the recording cannot continue.

Previous attempts have been made for remedy of such problems, such as described in for example EP 1111602, which discloses a servo adjustment apparatus for setting an adjustment value for servo control of at least one of optical recording of information on information recording surfaces and optical reproduction of information recorded on the information recording surfaces, is provided. A setting device sets an adjustment value corresponding to one of the information recording surfaces. Another setting device sets another adjustment value corresponding to another one of the surfaces other than the one of information recording surfaces. Then a calculation device calculates a relational value indicating a relationship between the adjustment value and another adjustment value. A storage device stores calculated relational value. A resetting device resets the adjustment value using another adjustment value set previously and the relational value when the adjustment value is reset, and resets another adjustment value using the adjustment value set previously and the relational value when another adjustment value is reset.

An object of the invention is to provide a method and a device, which makes possible a fast and reliable shift between the layers in an optical carrier having multiple layers.

In a first aspect of the invention, there is provided a method of adjusting operating conditions when shifting from a first layer to a second layer during recording of a multiple layer optical carrier. The method comprises: obtaining at least one property pertaining to said recording; obtaining at least one current value of an operating function for operating the recording of said first layer; and calculating a desired value of said at least one of operating function for operating the recording of said second layer, based on said at least one property and said current value. The property may be selected from the group comprising: temperature, prerecorded parameters and measured parameters during calibration of said first layer. The operating function may be selected from the group comprising: a tilt signal, a focus signal, a laser power and a beta target.

In a first embodiment, the operating function is a tilt offset signal applied to a tilt actuator for maintaining a movement direction of an objective lens substantially parallel with a disk surface at each given radial distance (x) from the disk centrum, whereby the calculation is performed according to the formula:

Layer_{—}1_Tilt_Offset(x)=Layer_{—}0_Tilt_Offset(x)*(1+[α_{T}×ΔT])

in which:

Layer_{—}1_Tilt_Offset(x) is the desired value of the tilt offset signal for layer 1

Layer_{—}0_Tilt_Offset(x) is the current value of the tilt offset signal for layer 0 used when recorded at said radial distance(x)

ΔT=the temperature difference between when the current value was obtained and the desired value is calculated

α_{T} is a factor that reflects the relationship between tilt sensitivity of tilt actuator and temperature.

In a second embodiment, the operating function is a focus control signal applied to a focus actuator for maintaining a distance from an objective lens to a recorded layer substantially constant, whereby the calculation is performed according to the formula:

Current_{—}L1_{—}FO=[Current_{—}L0_{—}FO+(Learnt_{—}L1_{—}FO−Learnt_{—}L0_{—}FO)×(1+[α_{F}×ΔT])

in which:

Current_L1_FO is the desired focus offset used during recording of the first data block in Layer 1.

Current_L0_FO is the current focus offset used during recording of last data block in Layer 0.

Learnt_L0_FO and Learnt_F1_FO are focus offset values for Layer 0 and 1 that was determined during start-up of fully recorded discs

ΔT is temperature difference between the instance when Learnt_L0_FO & Learnt_L1_FO is determined and the current temperature or the temperature when the system switches over from Layer 0 to Layer 1.

α_{F} is a factor that reflects the relationship between (tilt) focus sensitivity of focus actuator and temperature.

In a third embodiment, the operating function is a laser power signal applied to a laser source for recording on a layer, whereby the calculation is performed according to the formula:

Current_{—}L1_{—}LP=[Current_{—}L0_{—}LP+(Disc_{—}L1_{—}LP−Disc_{—}L0_{—}LP)]

in which:

Current_L1_LP is the desired laser power used during recording of the first data block in Layer 1

Current_L0_LP is the current laser power used during recording of the last data block in Layer 0

Disc_L0_LP and Disc_L1_LP are the indicative laser power stated in Physical Format Information field in the disc.

In a fourth embodiment, the operating function is a beta target signal applied to a driver for a laser source for recording on a layer, whereby the calculation is performed according to the formula:

Current_{—}L1_{—}BT=[Current_{—}L0_{—}BT+(Disc_{—}L1_{—}BT−Disc_{—}L0_{—}BT)]

in which:

Current_L0_BT is the beta target used during recording of last data block in Layer 0

Disc_L0_BT and Disc_L1_BT are the indicative beta target that is stated in an information field of the disc.

In another aspect, there is provided an apparatus for performing the above-mentioned method, for adjusting operating conditions when shifting from a first layer to a second layer during recording of a multiple layer optical carrier. The apparatus comprises at least one actuator operated by a control unit according to at least one operating function for operating the recording of said first layer; at least one memory for including at least one property pertaining to said recording; whereby said control unit calculates a desired value of said at least one of operating function for operating the recording of said second layer, based on at least one current value of an operating function for operating the recording of said first layer and said at least one property. The property may be selected from the group comprising: temperature, prerecorded parameters and measured parameters during calibration of said first layer. The operating function may be selected from the group comprising: a tilt signal, a focus signal, a laser power and a beta target.

Further objects, features and advantages appear from the following detailed description of embodiments of the invention with reference to the drawings, in which:

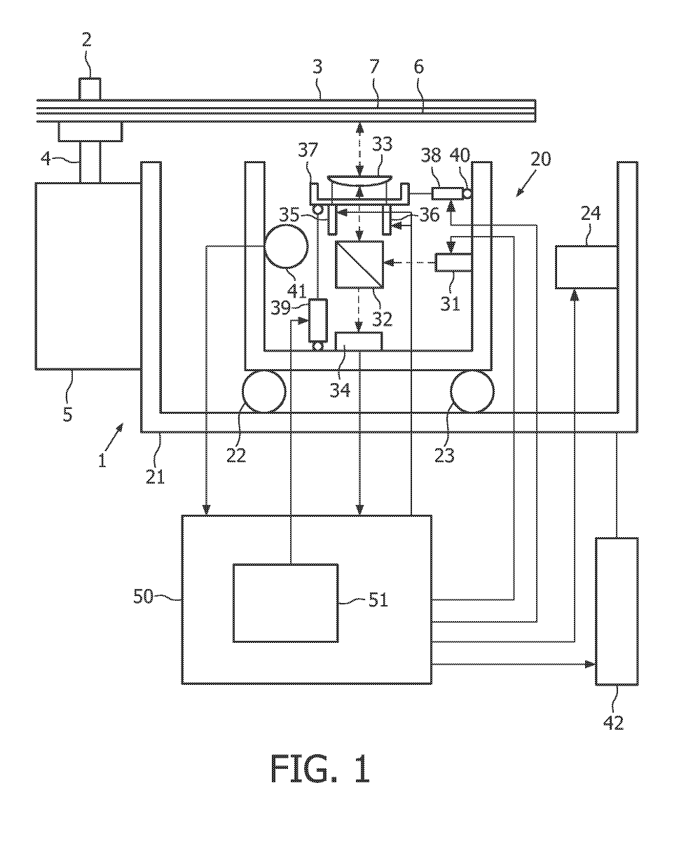

FIG. 1 is a schematic diagram of a disk drive in which the present invention may be used.

FIG. 1 is a schematic view of a disk drive and an optical unit in which the invention may be used.

The disk drive 1 comprises a disk holder 2 for holding a disk 3 for rotation by a shaft 4 driven by an electric motor 5. The disk is kept in a plane, which is carefully oriented perpendicular to the rotational axis of the shaft 4 in order to prevent wobbling of the disk. The optical disk may comprise multiple layers, whereby two layers 6 and 7 are shown in FIG. 1. Layer 6 is a first layer and layer 7 is a second layer.

An optical pick-up unit 20 is arranged below the disk. Unit or sledge 20 is moveable in the radial direction of the disk in a rail system 21 as indicated by wheels 22, 23. Unit 20 is moved in the radial direction by a track actuator 24. Track actuator 24 essentially moves the optical unit 20 so that it is placed opposite a track to be recorded.

The optical unit 20 comprises a laser source 31 emitting a powerful laser beam. The beam is directed towards a prism 32, which reflects the laser beam through a lens 33 towards the optical disk to be recorded and an optical layer 6 or 7 therein. A portion of the laser beam is reflected back via lens 33 and prism 32 to an optical sensor 34. Optical sensor 34 has multiple purposes, one of which being to ensure that the focused laser beam follows the track to be recorded.

Lens 33 is moveable towards the disk, i.e. vertically as seen in FIG. 1, so as to focus the laser beam to one of the layers 6 or 7. The movement is performed by two focus actuators 35 and 36 attached to the lens 33. The focus actuators 35 and 36 are attached to a holder 37. Of course, only one focus actuator may be used.

Lens 33 and holder 37 are also moveable in the radial direction by a radial lens actuator 38. In case the optical disk is somewhat eccentrically attached to the shaft 4, the tracks of the disk will move back and forth in the radial direction during one revolution. The radial lens actuator 37 may move the holder 37 and the lens 33 so that the lens follows such fast radial movements of the track. The amplitude of such radial movements may be small, such as +/−0.5 mm.

If the disk plane is not exactly perpendicular to the shaft axis of motor 5, the disk may wobble, so that the distance between the optical unit 20 and the disk varies over one revolution. Such wobbling means that the lens actuators 35 and 36 have to move the lens during one revolution so that the laser beam maintains the focus on the disk layer to be recorded.

In case the disk or the recording layer of the disk comprises a tilt in the radial direction, for example due to the fact that the surface has a small umbrella shape or other irregularities, the lens or holder is tiltable by means of a tilt actuator 39. The tilt actuator may move one end of the holder in the vertical direction seen according to FIG. 1. The holder rotates around a pivotable connection 40 between the radial lens actuator 38 and the optical unit 20. The tilt actuator may alternatively be two actuators operating at each radial end of the holder 37, so that the tilt does not influence upon the focus operation.

The entire rail system 21 may be tiltable in order to adjust to large or systematic tilt variations of the drive. Thus, a rail tilt actuator 42 may be arranged to adjust the rail system so that it is parallel with the local disk surface. Moreover, tilt acutator 42 is used for adjusting the distance between the optical pick-up unit 20 and the disk, so that the focus actuators 35 and 36 may operate in a suitable range.

Actuators 24 and 42 may be step motors or DC motors.

The actuators 35, 36, 38 and 39 may be of any suitable actuator type, such as piezo-electric or electromagnetic type similar to a loudspeaker driver.

Such actuators have a response on an electric signal provided by a control unit, which is dependent on the temperature of the surrounding environment. Thus, a temperature sensor 41 is included in the optical unit 20.

The optical sensor 34 and the temperature sensor 41 emits signal to a control unit 50. The control unit 50 emits control signals to control rail tilt actuator 42, and radial track actuator 24 for adjusting the rail system and the optical unit as appropriate. In addition, the control unit may control the motor 5 and other parameters and signals.

The control unit 50 also emits signals for controlling the focus actuators 35, 36 to maintain the laser beam in focus on a layer to be recorded. Moreover, the control unit emits signals for controlling the radial lens actuator 38 to follow the tracks. These two control operations are fast, because the optical unit must follow the tracks and keep the focus of the beam all the time, irrespectively if the disk is wobbling or non-concentric.

In order to reduce the adjustments required by focus actuators 35 and 36, the control system controls the tilt actuator 39 to follow the actual or local tilt angle of the surface of the disk or the layers of the disk. This control may be slower so that tilt actuator 39 is not adjusted for each revolution of the disk, but rather between two or more revolutions. The tilt applied for each track or a specific radial or x position may be stored in the memory 51 during the recording of the first layer.

When recording on a multiple layer optical carrier, such as a dual layer DVD, the optical pick-up unit 20 is first calibrated before the actual writing on the optical layers. Such calibration may take some time, up to 20 seconds or more. In a dual layer disk, the calibration must be repeated when shifting from the first layer to the second layer, since the layers have different properties.

Before calibration, a specific field called Physical Format Information field is read. This field comprises i.a. information about indicative power to be used during recording, and also indicative power for each layer in the dual layer DVD disk. Thus, a differential power level between the two layers may be determined from this information field and stored in a memory 51 of the control unit 50.

The field also comprises information about what beta target that should be used during recording for the two layers. Thus, also a differential beta target value between the two layers may be obtained and stored in the memory of control unit 50.

The power level may be used to program the set-point for the laser control loop such that the laser pulses applied by the drive onto the disc recording layer is scaled correctly. Correct power level is important for obtaining good recording performance or write jitter. Beta is a property or asymmetry of the recorded HF signal from the disc. Beta target is often used as feedback signal by the recording system while recording dye media discs for (continuously) calibrating the writing power level. For dye media discs, beta is directly proportional to effective write power. In other words, higher recording power will cause higher beta value in the recorded HF signal.

According to the present invention, during calibration, it is assumed that the distance between the two layers is approximately constant. The closed loop focal control system compensates for small deviations. The focus offset is calibrated to a value that gives the best reading or jitter performance.

According to the invention, during calibration, the power of the laser may alternatively be adjusted by recording on the layer of the disk in an area specifically reserved for calibration and determining an optimum laser power level and a beta value. The same procedure is performed for both layers and initial differentials for laser power and beta target are determined.

The recording normally start with layer one, which is layer 6 closest to the optical unit. When the first layer has been filled with data, the recording proceeds to the second layer.

According to the present invention, the information obtained during the initial calibration is used for making the shift time between the two layers as short as possible.

Normally, the shift between the two layers take place at the same radial position, i.e. the disk is recorded from the centrum and towards the periphery in the first layer. When the outermost track has been recorded in the first layer, the continued recording takes place on the second layer from the same radial position and towards the centrum. Thus, the shift between the two layers is performed without moving the pick-up unit in the radial direction.

The laser power to be used on the second layer may be calculated by adding the differential power level determined during the calibration, to the present laser power used just before the shifting.

The beta target to be used on the second layer may be calculated by adding the beta target obtained during the calibration, to the present beta target used just before the shifting.

It is assumed that the two layers are essentially parallel, which means that there will be the same tilt before and after the shifting, and the tilt actuator may be left as before the shifting.

The focus control offset has to be changed because there is a physical distance between the two layers. This offset was measured during the initial calibration. However, the distance signal has to be adjusted for temperature influence before being added to the focus actuator control circuit. There may be a large temperature difference between the time when the layer distance was measured during calibration and the time when there is a shift between the two layers. The focus control offset often have a relatively large temperature dependence. This temperature constant may be determined empirically, either when the disk drive was assembled, or intermittently, such as during each calibration.

In DVD recorder system, focus offset, tilt offset, laser power and beta target are four critical parameters that may have a large influence of the recording performance. These parameters are influenced by for example temperature, disc layer and disc radial position.

Below, the first layer is called layer 0 and the second layer is called layer 1.

The tilt offset is a signal applied to the lens tilt actuator 39 to ensure that the objective lens and the disc or the layer to be recorded on are in parallel planes. This parameter is very much affected by the tilt of the disc and optical pickup unit. It is also affected by temperature because tilt sensitivity of the optical pickup unit (OPU) is affected by temperature.

In a DVD Video recorder, the radial position of the last recorded block in layer 0 is equal to the radial position of first recorded block in layer 1. It can be also assumed that the planes of layer 0 and layer 1 are parallel to each other. Using this assumption, the tilt offset that must be applied when the system start to record layer 1 can be calculated by the following formula:

Layer_{—}1_Tilt_Offset(x)=Layer_{—}0_Tilt_Offset(x)*(1+[(α_{T}×ΔT])

where:

ΔT is temperature difference between the instance when last recording at radial position ‘x’ on Layer 0 and first recording on Layer 1 is being recorded.

α_{T} is the factor that reflects the relationship between tilt sensitivity of tilt actuator and temperature. It can be determined empirically.

Layer_{—}0_Tilt_Offset(x) is the tilt offset applied while recording at radial position ‘x’ in layer 0.

Layer_{—}1_Tilt_Offset(x) is the tilt offset applied while recording at radial position ‘x’ in layer 1.

Generally, the system can switch over to the next layer at any radius or x position. In the recording system, the optimum tilt value at different radius or x position is kept in an array of memory. Optimum tilt is often found at the first layer (layer 0) by calibrating the tilt offset to obtain the corresponding best jitter value. In the formula, the temperature factor compensates for the change in tilt sensitivity with respect to temperature. In drive actuator system, tilt sensitivity is affected by magnetic field strength and this property changes with temperature. If the tilt offset stored in the memory is calibrated at temperature TO and layer shift takes place at radius x and at temperature Ti, the new tilt applied must be compensated for temperature effect.

The focus offset is a signal applied to the actuator focus control to ensure the system achieve optimum recording performance. This parameter is very much affected by the characteristic of the disc and optical pickup unit. It is also affected by temperature because beam-landing and characteristic of the optical pickup unit (OPU) are affected by temperature. The focus offset that must be applied when the system starts to record layer 1 can be calculated by the following formula:

Current_{—}L1_{—}FO=[Current_{—}L0_{—}FO+(Learnt_{—}L1_{—}FO−Learnt_{—}L0_{—}FO)*(1+[α_{F}×ΔT])

where:

it is assumed that the time and temperature when the system record the last block on Layer 0 and the first block on Layer 1 is almost the same.

ΔT is temperature difference between the instance when Learnt_L0_FO & Learnt_L1_FO is determined and the current temperature or the temperature when the system switches over from Layer 0 to Layer 1.

α_{F} is the factor that reflects the relationship between tilt sensitivity of OPU and temperature. It can be determined empirically.

Current_L0_FO is the focus offset used during recording of last data block in Layer 0.

The Learnt_L0_FO and Learnt_F1_FO are focus offset values for Layer 0 and 1 that was determined during start-up of fully recorded discs. In the productions, this is calibrated once. It is important that Learnt_L0_FO and Learnt_L1_FO values are determined at almost the same instance or temperature.

The laser power that is used must be optimum to achieve good recording performance. This parameter is very much affected by the characteristic of the disc. The laser power that must be applied when the system start to record layer 1 can be calculated by the following formula:

Current_{—}L1_{—}LP=[Current_{—}L0_{—}LP+(Disc_{—}L1_{—}LP−Disc_{—}L0_{—}LP)]

where:

Current_L0_LP is the laser power used during recording of last data block in Layer 0.

Disc_L0_LP and Disc_L1_LP are the indicative power that is stated in Physical Format Information field in the disc. Drive could retrieve this information during starting up of the disc.

The beta target that is used must be optimum to achieve good recording performance. This parameter is very much affected by the characteristic of the disc. It is needed during the dynamic calibration of the laser power on layer 1. The laser power would be adjusted to achieve the target beta. The beta target that must be applied when the system start to record layer 1 can be calculated by the following formula:

Current_{—}L1_{—}BT=[Current_{—}L0_{—}BT+(Disc_{—}L1_{—}BT−Disc_{—}L0_{—}BT)]

where:

Current_L0_BT is the beta target used during recording of last data block in Layer 0.

Disc_L0_BT and Disc_L1_BT are the indicative power that is stated in Physical Format Information field in the disc. Drive could retrieve this information during starting up of the disc.

By using the method according to the invention as outlined above, it is possible to reduce calibration time, resulting in a reduced cost for memory buffer. Moreover, the robustness is improved as well as the reliability of the calibration process.

The calibration windows for laser power and servo offset is often small. If the system uses values outside the window during calibration, the system will have difficulty to even stay on track. As a result, the calibration will fail or the result will not converge to the desired value.

The method according to the invention makes use of existing information available to the system. This information is the parameters used in current layer, information obtained from the optical disk and parameters obtained during calibration in the factory. No new algorith or implementation is needed.

The method according to the invention may compliment existing direct calibration methods, which means that the present methods will not result in side effects in existing implementations, which can be used alternatively or as a complement.

All previously known methods require the system to access the target layer and perform the calibration during or shortly before the shift of the layers. Such prior art system do not address the situation if the calibration during the shift between the two layers fail. Using the method according to the present invention, there is no calibration during the shift, and consequently, there is no risk for calibration failure during the shift.

The present method makes it possible to skip the calibration during the shift entirely.

Alternatively, the method according to the invention can be used, if the normal calibration fails.

In another alternative, the values obtained according to the present invention can be used as starting values for a fast calibration during the shift according to any previously known method.

The invention can be implemented in any suitable form including hardware, software, firmware or any combination of these. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Above, the invention has been described in relation to certain embodiment shown on the drawings. However, such embodiments do not limit the invention but are only for illustrating the invention. The invention may be modified and completed in different manners as occurs to a person reading the specification and such modifications are intended to be within the scope of the invention. The invention is only limited by the appended patent claims.

1. A method of adjusting operating conditions when shifting from a first layer to a second layer during recording of a multiple layer optical carrier, the method comprising
obtaining at least one property pertaining to said recording;
obtaining at least one current value of an operating function for operating the recording of said first layer; and
calculating a desired value of said at least one of operating function for operating the recording of said second layer, based on said at least one property and said current value,
characterized in that
said operating function comprises controlling laser power for recording on a layer, and
said property comprises a parameter for controlling the laser power.

2. The method of claim 1, wherein said property is selected from the group comprising: temperature, prerecorded parameters and measured parameters during calibration of said first layer.

3. The method of claim 1, wherein said current value of said operating function is selected from the group comprising: a tilt signal, a focus signal, a laser power and a beta target.

4. The method of claim 1, wherein said operating function comprises a tilt offset signal applied to a tilt actuator for maintaining a movement direction of an objective lens substantially parallel with a disk surface at each given radial distance (x) from a disk center, whereby the calculation is performed according to the formula:
Layer_{—}1_Tilt_Offset(x)=Layer_{—}0_Tilt_Offset(x)*(1+[(α_{T}×ΔT])
in which:
Layer_{—}1_Tilt_Offset(x) is the desired value of the tilt offset signal for layer 1
Layer_{—}0_Tilt_Offset(x) is the current value of the tilt offset signal for layer 0 used when recorded at said radial distance (x)
ΔT=the temperature difference between when the current value was obtained and the desired value is calculated
α_{T} is a factor that reflects the relationship between tilt sensitivity of tilt actuator and temperature.

5. The method of claim 1, wherein said operating function comprises a focus control signal applied to a focus actuator for maintaining a distance from an objective lens to a recorded layer substantially constant, whereby the calculation is performed according to the formula:
Current_L1_FO=[Current_L0_FO+(Learnt_L1_FO−Learnt_L0_FO)×(1+[α_{F}×ΔT]) in which:
Current_L1_FO is the desired focus offset used during recording of the first data block in Layer 1.
Current_L0_FO is the current focus offset used during recording of last data block in Layer 0.
Learnt_L0_FO and Learnt_F1_FO are focus offset values for Layer 0 and 1 that was determined during start-up of fully recorded discs
ΔT is temperature difference between the instance when Learnt_L0_FO & Learnt_L1_FO is determined and the current temperature or the temperature when the system switches over from Layer 0 to Layer 1.
α_{F} is a factor that reflects the relationship between (tilt) focus sensitivity of focus actuator and temperature.

6. The method of claim 1, wherein said operating function comprises a laser power signal applied to a laser source for recording on a layer, whereby the calculation is performed according to the formula:
Current_{—}L1_{—}LP=[Current_{—}L0_{—}LP+(Disc_{—}L1_{—}LP−Disc_{—}L0_{—}LP)]
in which:
Current_L1_LP is the desired laser power used during recording of the first data block in Layer 1
Current_L0_LP is the current laser power used during recording of the last data block in Layer 0
Disc_L0_LP and Disc_L1_LP are the indicative laser power stated in Physical Format Information field in the disc.

7. The method of claim 1, wherein said operating function comprises a beta target signal applied to a driver for a laser source for recording on a layer, whereby the calculation is performed according to the formula:
Current_{—}L1_{—}BT=[Current_{—}L0_{—}BT+(Disc_{—}L1_{—}BT−Disc_{—}L0_{—}BT)]
in which:
Current_L0_BT is the beta target used during recording of last data block in Layer 0
Disc_L0_BT and Disc_L1_BT are the indicative beta target that is stated in an information field of the disc.

8. An apparatus for performing the method of claim 1, for adjusting operating conditions when shifting from a first layer to a second layer during recording of a multiple layer optical carrier, comprising
at least one control unit according to at least one operating function for operating the recording of said first layer;
at least one memory for including at least one property pertaining to said recording;
whereby said control unit calculates a desired value of said at least one of operating function for operating the recording of said second layer, based on at least one current value of an operating function for operating the recording of said first layer and said at least one property,
characterized in that
said operating function comprises controlling laser rower for recording on a layer, and
said property comprises a parameter for controlling the laser power.

9. The apparatus of claim 8, wherein said property is selected from the group comprising: temperature, prerecorded parameters and measured parameters during calibration of said first layer.

10. The apparatus of claim 8, wherein said current value of said operating function is selected from the group comprising: a tilt signal, a focus signal, a laser power and a beta target.

11. An apparatus for writing information to a multiple layer optical carrier, comprising the apparatus according to claim 8.
